(19) United States
(12) Patent Application Publication
(10) Pub. No.: US 2016/0083034 A1
(43) Pub. Date: Mar. 24, 2016

(54) HELMET LOCKING DEVICE

(71) Applicant: Martin St-Gallay, East Molesey Surrey (GB)

(72) Inventor: Martin St-Gallay, East Molesey Surrey (GB)

(21) Appl. No.: 14/784,865

(22) PCT Filed: Apr. 14, 2014
(86) PCT No.: PCT/EP2014/057550

§ 371 Date: Oct. 15, 2015

(30) Foreign Application Priority Data
Apr. 15, 2013 (GB) 1306831.7

(51) Int. Cl. B62J 11/00; B62H 5/00

(52) U.S. Cl. CPC B62J 11/005; B62H 5/001

(57) ABSTRACT

A device having a base element affixed to or for affixing to a frame of a bicycle, a helmet-engaging element for passing through an aperture in the helmet in order to secure it, which is attached to or mounted on the base element and moveable between stowed and operational configurations and a locking element for locking to at least a part of the engaging element provides a helmet locking system which may fit or adapt to any bicycle and enables any cycle helmet having ventilation holes to be locked to the bicycle when not in use, without the need to carry additional equipment and regardless of who is riding the bicycle or which helmet they are using.

### FIELD OF THE INVENTION

This invention relates to the field of locking devices. In particular, it relates to a device for locking or fixing a safety helmet to a vehicle such as a bicycle, especially a vehicle that is immobilised, such as a bicycle securely parked in a public place.

### BACKGROUND OF THE INVENTION

Cycling is becoming increasingly popular both as a leisure activity and as a means of transport, e.g. for commuting to work. Most cyclists prefer to wear a safety helmet, and this may in fact become a legal requirement, as it already has in some countries.

This raises the problem of what to do with the helmet after parking the bicycle in a theft-proof manner. The cable used to tie the bicycle itself to a parking facility is unsuitable for securing the helmet as well, because the helmet would then be near the ground, with all the drawbacks of it, or the cable is too short for this, or else there is no room for the helmet in the bike rack in such a case.

In the absence of a suitable device for securing the helmet to the bicycle, the cyclist must take the helmet and carry it to work, to the shops, etc. This is obviously a nuisance, especially because of the awkward shape of the helmet.

Several attempts have been made to solve this problem.

The incorporation of a locking device into bicycle helmet chinstraps (or its association with these) is described in GB-A-853461, WO-A-2012/028742 and WO-A-2010/128005. However, this can make the chinstrap unwieldy and requires the incorporation of a device into a helmet, so the user has to obtain a new helmet and the same helmet needs to be used when cycling.

U.S. Pat. No. 6,415,635 describes a locking device for a helmet which comprises two parts, a lock case which may be affixed permanently to the saddle support tube of the frame of a bicycle which case is configured to receive a lock head in a direction perpendicular to the saddle support tube, and an extended longitudinal rod in an L-shape having one short rod shank and one long rod shank, each end having a locking head for fitting and locking into the lock case. A bulbous joint between the short and long rod shank is provided so that when the long rod shank is passed through a ventilation hole in a helmet and its locking head secured into the lock case, the bulbous joint prevents the whole of the longitudinal rod passing through the whole and enables the helmet to be securely held onto the bicycle. In use, the long rod shank passes through the helmet and is locked into the lock case holding the helmet in the space in the main frame of the bicycle. In its rest configuration, the locking head of the short rod is locked into the lock case such that the long rod shank is stowed parallel with the support tube. This has the disadvantage that the lock is difficult to access (being between the support tube and back wheel), attaching the helmet is cumbersome and may obstruct the pedals, stores the helmet low down on the bike and requires a rigid element to be stowed which may catch on clothing etc.

CA-A-2132996 describes a helmet lock comprising a mounting plate for mounting onto a bicycle frame and having a lock for receiving a lock head, and a corresponding T-shaped rigid element with a lock head for passing through an air vent in the helmet and engaging with the lock on the mounting plate. This rigid element (of a fixed length) could be cumbersome and makes attaching the helmet fiddly.

There remains therefore a need for a device that makes it possible for cyclists to conveniently store their helmet with the bicycle in a way that makes its theft as difficult as that of the bicycle itself (when locked or tied to a parking facility, for example).

The present inventor has devised a device that remedies the disadvantages of the prior art.

### PROBLEM TO BE SOLVED BY THE INVENTION

There is a need for improved devices, systems and methods for securely locking articles such as helmets to vehicles such as bicycles, motorcycles and scooters.

It is an object of this invention to provide a device that is efficient to manufacture and effective in securely locking an article such as a cycle helmet to a vehicle such as a bicycle.

### SUMMARY OF THE INVENTION

Accordingly, there is provided in a first aspect of the invention a device for securing a safety helmet to a vehicle such as a bicycle, the device comprising:
a base element affixed to or for affixing to the vehicle (e.g. the frame of a bicycle);
a helmet-engaging element for passing through an aperture in the helmet in order to secure it, the helmet-engaging element being attached to or mounted on the base element and being moveable between a compact stowed configuration and an extended operational configuration; and
a locking element to for receiving and locking to at least a part of the engaging element.

In a second aspect of the invention, there is provided a bicycle having a frame and integrated therewith a device as defined above.

In a third aspect of the invention, there is provided a method for temporarily securing a safety helmet to a bicycle, the method comprising: providing on the bicycle a device as defined above whereby a base element is established on or fixedly mounted to a frame of the bicycle, causing a helmet-engaging element to be moved to its operational configuration, passing a first end of the helmet-engaging element through a hole in the helmet (e.g. a ventilation hole), causing at least a portion of the engaging element to cooperate with the locking element and causing the locking element to be secured to the engaging element, whereby the safety helmet is securely locked to the bicycle.

In a fourth aspect of the invention, there is provided a locking device for locking an accessory having a hole for engagement to an article having a means for attachment, the locking device comprising:
a base element for affixing to the article by the means for attachment;
an accessory-engaging element for passing through an aperture in the accessory in order to secure it to the article, the engaging element being attached to or mounted on the base element and being moveable between a compact stowed configuration and an extended operational configuration; and
a locking element to for receiving and locking to at least a part of the engaging element.

### ADVANTAGES OF THE INVENTION

The device of the present invention may be fitted or adapted for any bicycle and enables any cycle helmet having ventilation holes to be locked to the bicycle when not in use, without the need to carry additional equipment and regardless of who is riding the bicycle or which helmet they are using. It also enables the helmet to be stored in a manner that allows it to be covered and kept away from the ground.

### BRIEF DESCRIPTION OF THE DRAWINGS

FIG. 1 shows an exploded view of the various components of a device according to one embodiment of the invention showing the two incorporating parts;

FIG. 2 shows a device of one embodiment of the invention in its two parts;

FIG. 3 shows a device of one embodiment of the invention in full, resting assembly;

FIG. 4 shows a device of FIG. 3 fixed to the handlebar of a bicycle, and

FIG. 5 shows a device of FIG. 4 with a helmet secured thereto.

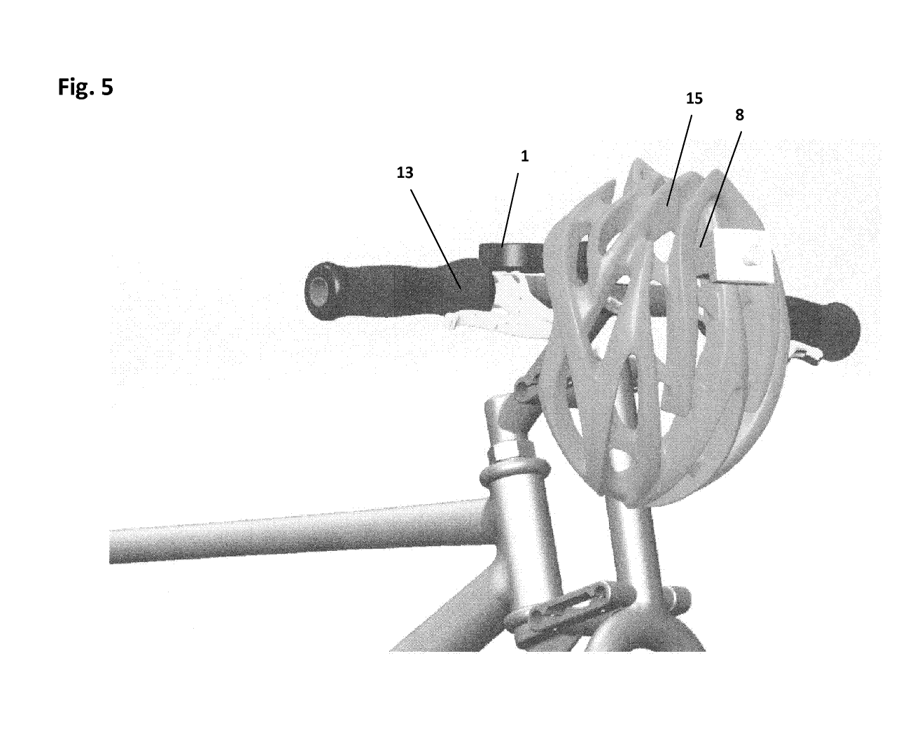

### DETAILED DESCRIPTION OF THE INVENTION

The present invention provides a device, being means by which a safety helmet may be secured to a vehicle, especially a vehicle having handlebars such as a motorcycle, moped, motor scooter, scooter, tricycle or bicycle. More preferably, the vehicle is a pedal cycle such as a bicycle or tricycle, and most preferably a bicycle.

The description hereinafter is directed primarily to the embodiment in which the vehicle is a bicycle. It should be understood however that the features are also applicable to the generality of vehicle and other specified vehicles where the context allows.

The device comprises a base element, a helmet-engaging element attached to or mounted on the base element and a locking element (for receiving and locking to the engaging element).

The base element should be integral to or mounted/fixed or mountable/fixable (typically demountable) to the vehicle and, in the case of a bicycle preferably to the handlebars (or other part of the frame of the bicycle). Thus, the base element in the non-integral embodiment preferably comprises a fixing means for affixing the base element to the frame of a bicycle. Ideally, such a fixing should be secured with a screw fixing or locked (rather than a quick release fixing). Preferably, the base element forms a housing for the helmet-engaging element.

The helmet-engaging element is for passing through an aperture in the helmet in order to secure it. The helmet-engaging element is attached to or mounted on the base element and therefore is the means by which a helmet may be held onto the bicycle (or other vehicle). The helmet-engaging means is moveable between a compact stowed configuration and an extended operational configuration.

In a preferred embodiment, the helmet-engaging element in its compact stowed configuration is retained within (or at least partially within) a housing provided by the base element and in its extended operational configuration extends from (or at least partially extends from) the housing.

Preferably, the helmet-engaging element is extendible. Optionally, the engaging element may be rigid or flexible. For example, the engaging element may be a rigid telescopic rod or it may be an elastic or inelastic flexible cable.

In a preferred embodiment, the engaging element is flexible. The engaging element may be, for example, an elastic rope or rod that may be retained within a housing and then stretched to engage with a helmet (e.g. via the ventilation holes in a bicycle helmet) before securing to a locking element. Alternatively and more preferably the engaging element is a length of cable having a compact stowed configuration preferably in a coil which may be held within a housing provided by the base element (e.g. on a reel rotatably mounted within the housing) and an extended operational configuration in which an end of the cable extends (to at least some extent) from the housing and the cable is at least partially uncoiled from its stowed position. Preferably, the cable is biased to its stowed position, such as by way of a spring arrangement associated with a reel for holding the coiled or wound cable within the housing.

The engaging element preferably is elongate and comprises a first end (e.g. proximal end) attached or mounted (securely) to the base element (e.g. the centre post or core of a reel holding a wound cable of the engaging element) and a second, free end typically for passing through an aperture of a helmet to engage it and to be received by a corresponding locking element. The free end of the engaging element is preferably provided with a lock engagement head, which may be in the form of a moulded, re-inforced or spliced loop to which a locking element may be secured or on which a lock head may be formed which is configured to engage with a locking element.

The locking element is preferably configured to lock to the engaging element, the lock being securely retained and/or releasable (i.e. operable) by way of a key or combination key (mechanical or electronic), key card operated electronic lock or credit card operated electronic lock, or biometric identification system. Preferably, the lock is operable by way of a key.

The locking element may be a discrete unit, by which it is meant an unattached separate unit, so that it is not attached to the base element or otherwise to the vehicle (e.g. bicycle frame) apart from to the engagement element (upon engagement and locking thereto). Alternatively, the locking element may form a part of or be attached to the vehicle (e.g. the frame of a bicycle) or the base element, especially in the embodiment of the invention in which the engagement element is flexible. According to such an embodiment, a locking element may be a part of the base element. In use according to such an embodiment, the user may draw or pull the engagement element by the free end (having a lock engaging head), pass it through an aperture in the safety helmet, then either pass it back through a second aperture or directly to the locking element portion of the base element and engage the free end into the locking element and causing the locking element to securely lock to the engaging element. Thereby, the helmet may be securely retained on the vehicle.

In a preferred embodiment, the locking element is a discrete unit. On locking with the engaging element after passing it through an aperture of a helmet, the locking element should be configured to prevent the return of the entirety of engaging element freely back through the aperture to the base element and should prevent removal of the helmet. Thus the helmet may be secured to the vehicle (e.g. bicycle). This is typically achieved by the locking element being dimensioned to prevent its passage through the aperture (or at least configured in its locked configuration to be dimensioned to prevent its passage through the aperture of the helmet engaged by the engagement element). Preferably, the locking element should have dimensions of at least 2.5 cm in three directions, preferably at least 3 cm. Optionally, the dimensions should be at least 5 cm in at least one dimension (e.g. orthogonal to the helmet-engaging element longitudinal direction at its point of contact with the locking element), and optionally in a second dimension (e.g. also orthogonal to the longitudinal direction of the helmet-engaging element) and optionally a third dimension (e.g. the longitudinal direction of the engaging element). Optionally the dimensions in one or each dimension should be up to about 10 cm, optionally up to 7.5 cm, optionally up to 6 cm.

In a particularly preferred embodiment of the invention, the device is for use with a bicycle and comprises a base element that is either integral with the handlebars of the bicycle or is mounted or mountable on the handlebars of the bicycle. The base element comprises a housing (and in the non-integral form, comprises a housing having a means for mounting the housing onto the handlebars) in which a reel is located and configured for rotation about its core. Attached to the reel (and therefore to the base element) a flexible cable for engaging with a bicycle helmet is provided (attached at a first end e.g. to the core of the reel) which cable is coiled about the reel (in the compact configuration, which it is biased to) and from which it may be extended from the housing by pulling the free end of the cable (which is provided with a locking head). The cable may be extended and passed through an aperture of a helmet and the free end of the cable (having the locking head) engaged with a locking element (e.g. by inserting a locking head into a locking aperture provided in the locking element for its receipt). The dimensions of the locking element may prevent the cable from passing back through the aperture in the helmet. The cable may partially coil back into the housing to hold the helmet to the handle bars in a secure position.

Preferably, when the engaging element is in its stowed position, the base element and the locking element are so configured that the locking element may be stowed on the base element, e.g. by locking it over an aperture from which the engagement cable may extend.

The base element should be affixed or mounted to the frame of a bicycle, especially the handlebars, in a manner that is effectively permanent (e.g. using locking nuts or tamper-proof fixings).

Optionally, a waterproof cover (preferably a breathable waterproof cover) may be provided to fit over the helmet in situ locked to a bicycle (e.g. after locking the helmet to the bicycle).

Optionally, the device further comprises a light or reflector, preferably in which the lighting or reflecting element is a part of a discrete locking element (e.g. an end plate on the locking element) and optionally a power source for a lighting element may be included either in the locking element (e.g. batteries) or may be provided in the base element whereby appropriate electrical connection is made when the locking element is locked to the base element in its stowed configuration according to one mentioned embodiment of the invention. Optionally, the discrete locking element comprises a light or reflector on one face and a locking mechanism (e.g. key, card or biometric operative means) on another face (e.g. an adjacent face).

Preferably, according to a preferred embodiment where the helmet-engaging element is a cable, the cable may have a length of greater than 20 cm, preferably from 30 to 50 cm when fully extended (whereby it can be moved to permit easy access for the removal of the helmet and it can optionally be used to store more than one helmet or other item having an engageable aperture).

Optionally, in an embodiment of the invention in which the base element is integrated into the bicycle, the workings of the device can be hidden within the tubing of a bicycle. For example, the workings may be hidden within the handlebars such that the engagement element may extend from a pod formed on the handlebars. Alternatively, the end of a handlebar (forming for example a reflector) may double as a locking element, which may be removed to reveal the end of a cable or elongate engaging element which may be extended therefrom against a bias and engaged with a helmet by passing a free end of the engaging element through an aperture in the helmet and locked thereto by reattaching the locking element to the free end.

In another aspect, there is provided a locking device for locking an accessory having a hole for engagement to an article having a means for attachment, the locking device comprising: a base element for affixing to the article by the means for attachment; an accessory-engaging element for passing through an aperture in the accessory in order to secure it to the article, the engaging element being attached to or mounted on the base element and being moveable between a compact stowed configuration and an extended operational configuration; and a locking element to for receiving and locking to at least a part of the engaging element. Further features may be as described above for other aspects where the context allows.

The invention will now be described in more detail, without limitation, with reference to the accompanying Figures.

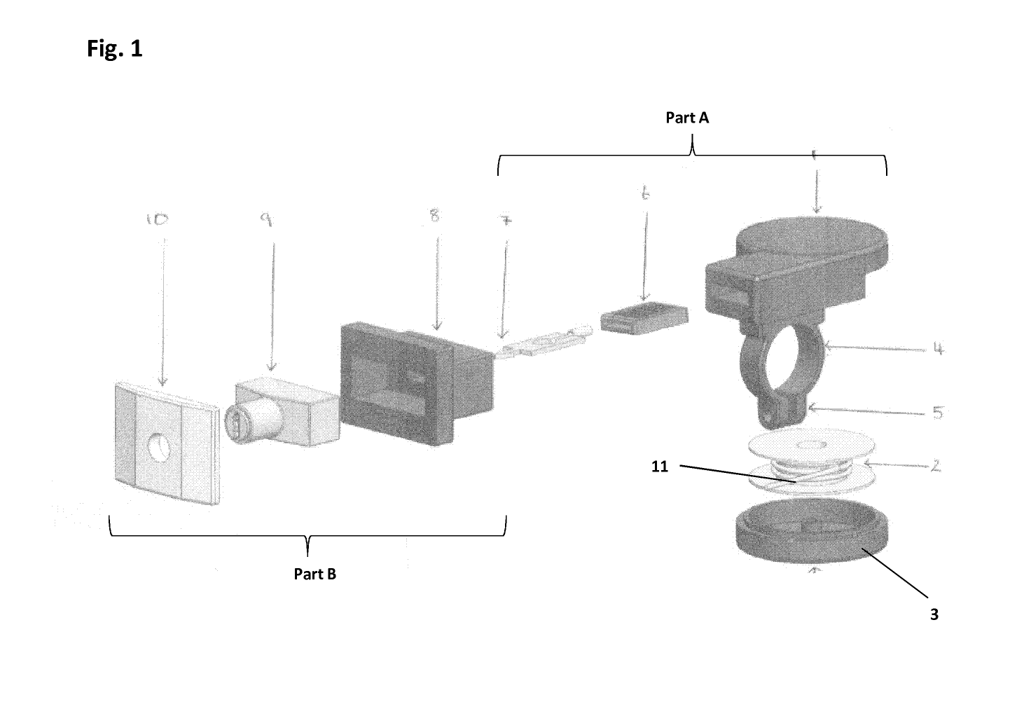

As can be seen from FIG. 1, the device in one embodiment comprises two discrete elements, Part A being a base element housing and helmet-engaging cable and Part B being the discrete locking element. Part A comprises an essentially circular cable housing 1 which accommodates a cable roll (or reel) 2 and which together with a bottom part 3 and circular clamp 4 form a base element and which reel 2 carries a retractable plastic-coated cable 11 having a metal core. The cable 11, which may be similar or identical to the one used for securing the bicycle itself to a parking facility, is wound up on a spring-loaded mechanism accommodated in the bottom part 3 of the cable housing 1, so it can be pulled out from the latter and it returns to it automatically. The cable housing 1 is closed at the bottom with the aid of a bottom part 3. Part A also comprises a circular clamp 4 for fixing the cable housing 1 to the handlebar of a bicycle with the aid of a fixed (undetachable) bolt 5. These three components 1, 2, 3, 4 and 5 may form a single moulded unit, which is fixed to the handlebar by the user and which remains there for successive use.

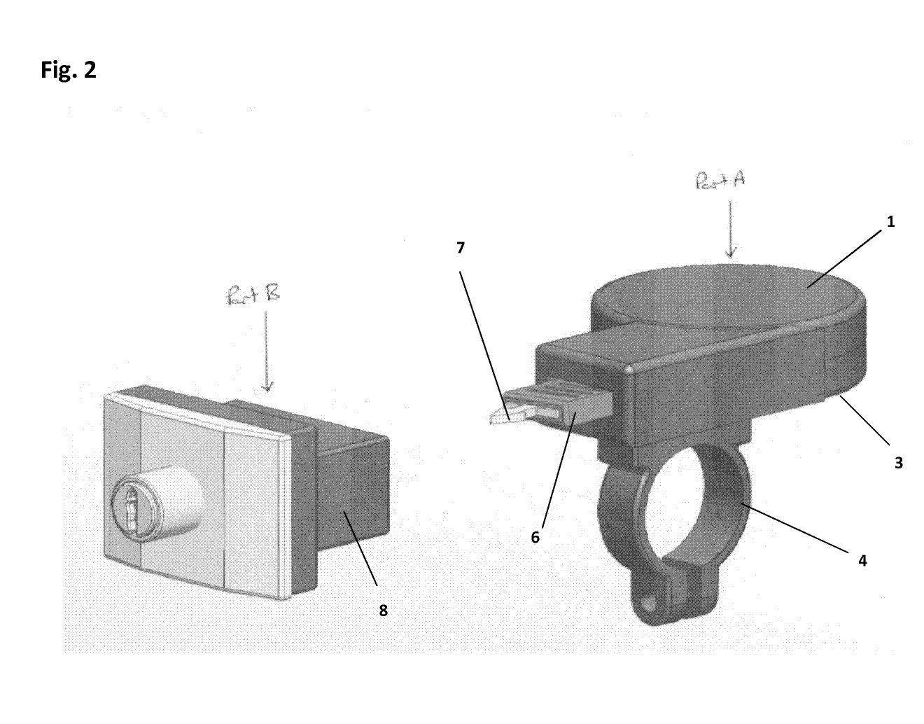

Part A also comprises (in the respective embodiments illustrated in FIGS. 1 and 2) a pull-tab 6 for pulling the cable out of the cable housing 1, as well as the male part 7 of the lock, which is firmly attached to the pull-tab 6. The cable dispensed from the cable housing 1 is threaded through the pull-tab 6 and is fixed to the male part 7 of the lock.

FIG. 2 also shows that Part B comprises a lock holder 8 and a key-actuated female part 9 of the lock. The male part 7 of the lock is joined to the female part 9 inside the lock holder 8, and the latter is fitted with an end plate 10 to prevent the device from being dismantled by an unauthorized person. The lock that fixes the male part 7 and the female part 9 together is actuated by a key (not shown).

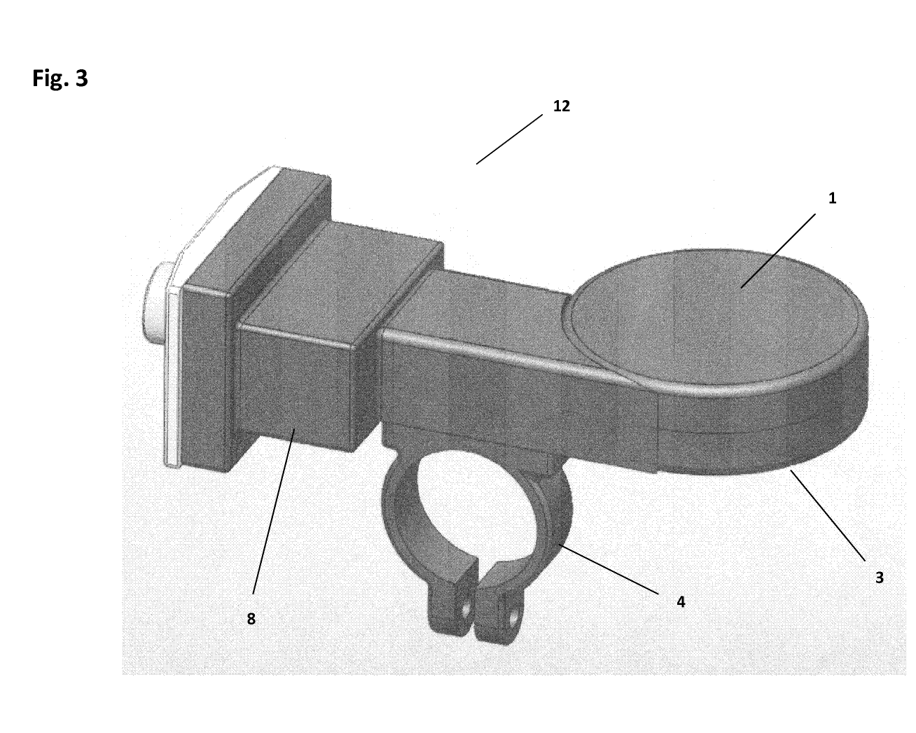

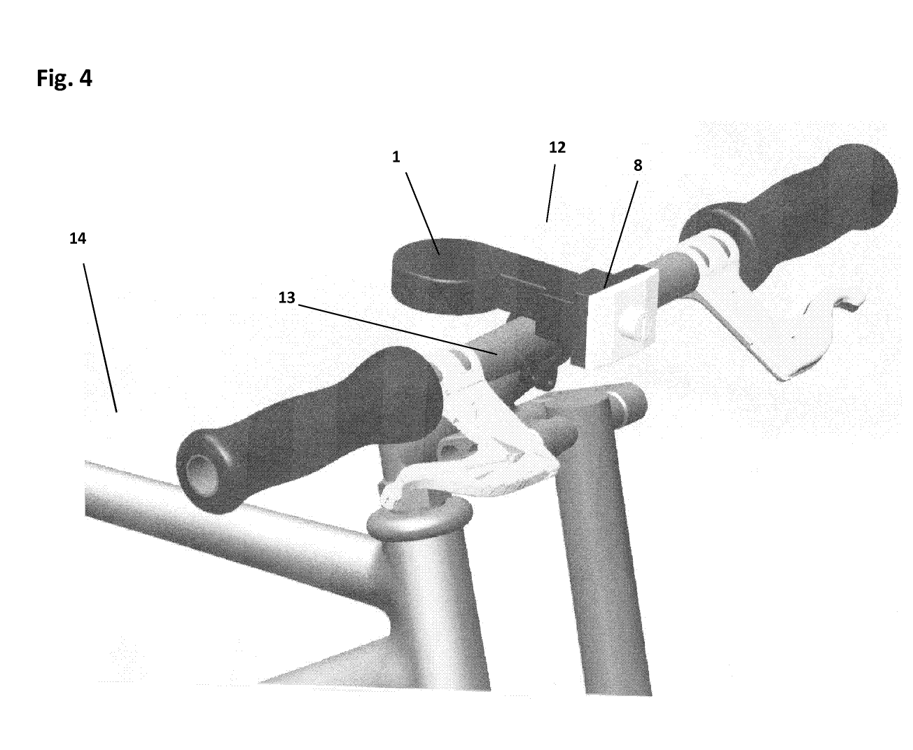

Parts A and B shown in FIG. 2 are combined to form an assembly 12 shown in FIG. 3, which is then fixed to the handlebar 13 of a bicycle 14 with the aid of an undetachable bolt (a one-off operation, prior to the first use). The result is shown in FIG. 4.

Once the device has been fitted to the handlebar, it is used as follows in order to fix the helmet 15 to a securely parked bicycle:
the key is turned in the lock, and part B is pulled apart from part A
holding the pull-tab 6, the cable connected to it is threaded through one of the holes in the helmet, and the male part of the lock 7 is then re-inserted into the lock holder 8, where it engages with the female part 9 of the lock;
the key is turned in the lock, and the bicycle is left in its parked position.

To remove the locked helmet, these steps are carried out in the reverse order.

The size and shape of the device and its components, as well as the materials used for making them can vary according to manufacturing circumstances and the size of the helmet to be locked.

The invention has been described with reference to preferred embodiments. However, it will be appreciated that variations and modifications can be effected by a person of ordinary skill in the art without departing from the scope of the invention.

1. A device for securing a safety helmet to a vehicle such as a bicycle, the device comprising:
a base element affixed to or for affixing to the vehicle;
a helmet-engaging element for passing through an aperture in the helmet in order to secure the helmet, the helmet-engaging element being attached to or mounted on the base element and being moveable between a compact stowed configuration and an extended operational configuration; and
a locking element to for receiving and locking to at least a part of the engaging element.

2. The device as claimed in claim 1, wherein the base element is a housing for housing the engaging element in the compact configuration and from which the engaging element extends in the operational configuration.

3. The device as claimed in claim 1, wherein the base element is integral with the vehicle.

4. The device as claimed in claim 1, wherein the base element is securely attachable to the vehicle.

5. The device as claimed in claim 1, wherein the engaging element is an extendible engaging element.

6. The device as claimed in claim 1, wherein the engaging element is flexible.

7. The device as claimed in claim 1, wherein the engaging element comprises a length of cable having the compact stowed configuration in a coil within a housing as the base element and the extended operational configuration in which an end of the cable extends from the housing and the cable is at least partially uncoiled from the compact stowed position.

8. The device as claimed in claim 1, wherein the engaging element is a flexible, elasticated cable.

9. The device as claimed in claim 1, wherein the engaging element is a rigid extendible element.

10. The device as claimed in claim 1, wherein the engaging element is elongate and is fixedly attached or mounted to the base element at one end thereof and another end is a free end.

11. The device as claimed in claim 1, wherein the locking element is a part of the base element and the engaging element engages the helmet by passing through an aperture therein and then is locked in place in the locking element on the base element.

12. The device as claimed in claim 1, wherein the locking element is a discrete unit separate from the base element which is configured to receive and lock to at least a part of the engaging element, the locking element comprising a lock and being so configured as to prevent passage of the locking element through the aperture in the helmet, thereby securing the helmet to the vehicle.

13. The device as claimed in claim 1, wherein the vehicle is a bicycle.

14. A bicycle having a frame and integrated therewith a device as defined in claim 1.

15. A method for temporarily securing a safety helmet to a bicycle, the method comprising: providing on the bicycle a device as defined in claim 1 wherein a base element is established on or fixedly mounted to a frame of the bicycle, causing a helmet-engaging element to be moved to its operational configuration, passing a first end of the helmet-engaging element through a hole in the helmet causing at least a portion of the engaging element to cooperate with the locking element and causing the locking element to be secured to the engaging element, whereby the safety helmet is securely locked to the bicycle.

16. A locking device for locking an accessory having a hole for engagement to an article having a means for attachment, the locking device comprising:
a base element for affixing to the article by the means for attachment;
an accessory-engaging element for passing through an aperture in the accessory in order to secure it to the article, the engaging element being attached to or mounted on the base element and being moveable between a compact stowed configuration and an extended operational configuration; and
a locking element for receiving and locking to at least a part of the engaging element.

17. (canceled)

18. The device as claimed in claim 9, wherein the rigid extendible element is a telescopic rod.

19. The device as claimed in claim 10, wherein the free end further comprises a lock engagement head for receipt by a locking element.

20. The method as defined in claim 15, wherein the hole is a ventilation hole.
